(19) United States
(12) Patent Application Publication
(10) Pub. No.: US 2006/0194698 A1
(43) Pub. Date: Aug. 31, 2006

(54) Use of herbs as a delivery system for bioactive phytochemicals

(76) Inventors: Kimberly D. Gwinn, Knoxville, TN (US); James F. Green, Knoxville, TN (US); Susan Hamilton, Knoxville, TN (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/541,048

(22) PCT Filed: Jul. 15, 2003
(86) PCT No.: PCT/US03/22272

§ 371 Date: Apr. 4, 2006

Related U.S. Application Data
(60) Provisional application No. 60/437,943, filed on Jan. 3, 2003.

(51) Int. Cl. A01N 65/00

(52) U.S. Cl. 504/117; 424/725

(57) ABSTRACT

The subject invention provides methods for cotrolling weeds, plant pests, or plant pathogens comprising the application of a bioactive herbage (plant material) composition to soil as a soil amendment or as top dressing for potted plants. In certain embodiments, the method of controlling weeds, plant pests, or plant pathogens comprises the application of a bioactive herbage (plant material) composition to soil as a soil amendment or as top dressing for potted plants in amounts sufficient to control weeds, plant pests, or plant pathogens, wherein said bioactive herbage is obtained from: (a) Monarda spp.; (b) Chamaemelum spp.; (c) Matricaria spp.; (d) Chenopodium spp.; or (e) various combinations of thereof. Herbage can be dried or wet and other sources of bioactive herbage are also suitable for use in the subject invention are provided.

### BACKGROUND OF INVENTION

The threat of large crop losses due to soil borne pathogens in floriculture greenhouse production systems can lead to overuse, and sometimes illegal use, of pesticides. Also, situations exist where disease control with synthetic pesticides is either ineffective or impossible (e.g., no registered pesticides available or pesticide-resistant pathogens).

Plants and microorganisms produce an arsenal of chemical weapons to escape herbivores and competitors and to ensure their survival. Since antiquity, man has exploited these chemicals (natural products) in agriculture and medicine; bioactive natural products continue to be investigated as valued sources of new compounds in these industries. Tens of thousands of these compounds have been isolated and identified; countless more remain to be discovered. For example, chemical composition is known for only 20-30% of higher plants.

Pest control in commercial plant production is costly both to the producer and to the environment. In 1998, U.S. farmers paid $8.8 billion for pesticides. The homeowner and recreational turf industry also represent markets with widespread usage of pesticides. Alternative pest management strategies, including natural products derived from plants and beneficial microorganisms, have been targeted for development by the USDA as potential solutions to the problems created by traditional chemical pesticides. Use of plant and microbial distillates and extracts for control of diseases and pests is stimulated by consumer demand for natural products often over lower cost synthetic ingredients. Natural products from native plants (e.g., bee-balm, goosefoot) as well as established crops (e.g., peppers, soybean) are being investigated for biological control. Natural products from microorganisms (e.g., Saccharopolyspora spinosa, Cercospora spp., Metarhizium spp. and Beauveria spp.) are used commercially or have potential for pest control.

In addition, there are many plant diseases, insect pests, and weeds that are not effectively controlled by traditional chemical pesticides. Several factors, including genetic resistance of pests to pesticides, can limit efficacy of man-made bioactive compounds. More effective control methods for plant pathogens, insect pests and weeds are needed, especially those representing new modes of action. Many pests are sensitive to chemicals naturally produced in plants and microorganisms. Further research in this area is needed to identify bioactive natural products that can be developed into environmentally benign, efficient control methods for pests in agriculture and in urban landscapes.

The soil fumigant methyl bromide is an example of an important pesticide that will be banned in the U.S. due to environmental concerns. Methyl bromide effectively eliminates plant pathogens and nematodes in soil, and suppresses weed growth but will be phased out under the Montreal Protocol (a treaty signed by over 160 countries that controls global production and trade of ozone-depleting substances). The ban on methyl bromide becomes effective in 2005 in developed countries and is expected to result in losses of $400-450 million in the U.S. Development of biologically-based alternatives to methyl bromide and other environmentally harmful pesticides is urgently needed to sustain modern agriculture.

The USDA Ethnobotanical and Phytochemical Database lists over 50 phytochemicals as herbicidal. Many of these phytochemicals are seed germination inhibitors. Invasion of weeds into perennial plant production systems results in losses. Customers are reluctant to purchase plants that contain weed species because weeds reduce the aesthetic appeal of the potted plant and are introduced into the landscape. Removal of weed species is costly in time and labor.

Several important issues threaten the stability of U.S. agriculture. These issues include: a) concerns about human and animal health, food quality, and the environment related to use of traditional chemical pesticides; b) the need for effective and inexpensive control measures for plant pathogens and pests, and weeds, that will enable us to increase the world food supply; c) the need for effective substitutes for such pesticides as methyl bromide and chlorpyrifos (Dursban and Lorsban) that are being phased-out by the U.S. Environmental Protection Agency; d) the desire for alternative crops for tobacco; and e) global climate change, which in the U.S. will increasingly drive changes in the distribution of preferred crops and crop pests.

### SUMMARY OF THE INVENTION

The subject invention provides methods for controlling weeds, plant pests, or plant pathogens comprising the application of a bioactive herbage (plant material) composition to 1) soil, greenhouse growing media, or nursery growing media as an amendment or 2) as top dressing for potted plants. In certain embodiments, the method of controlling weeds, plant pests, or plant pathogens comprises the application of a bioactive herbage (plant material) composition to soil as a soil amendment or as top dressing for potted plants in amounts sufficient to control weeds, plant pests, or plant pathogens, wherein said bioactive herbage is obtained from: a) Monarda spp.; b) Chamaemelum spp.; c) Matricaria spp.; d) Chenopodium spp; or e) various combinations of thereof. Herbage can be dried or wet and other sources of bioactive herbage are also suitable for use in the subject invention are provided.

### BRIEF DESCRIPTION OF THE FIGURES

FIG. 1 illustrates the total number of weeds observed in plants treated with various Monarda cultivars.

FIG. 2 depicts weed germination in relation to Monarda cultivars.

### DESCRIPTION OF THE INVENTION

The subject invention provides for the control of soil borne fungal pathogens including, but not limited to, Fusarium, Pythium, Rhizoctonia, Sclerotinia and Verticillium comprising the use of bioactive herbage, either alone or in combination with other registered biological control agents. In various embodiments of the subject invention, bioactive herbage is applied to: 1) soil, greenhouse growing media, or nursery growing media as an amendment or 2) as top dressing for potted plants. In a preferred embodiment, the bioactive herbage comprises Monarda herbage and, optionally, epazote. In some embodiments, the herbage is ground into particles of about 1 to about 5 mm in diameter. In certain embodiments the particles are about 1 mm or about 5 mm in diameter. The genus Monarda or bee-balm (Labiatae) consists of 16 aromatic annual or perennial herbs valued for their showy flowers, fragrant foliage and attraction of bees, butterflies and hummingbirds. All are native to North American ranging from Mexico through most of the United States to the prairies of Canada. Monarda didyma (common name Oswego tea) is the most popular perennial species on today's market. It is one of the most popular species for its showy red color in the garden and its ability to attract hummingbirds and butterflies. Cultivars of this species grown commercially are available in a variety of colors other than red, including: white, pink, salmon, violet, and purple. In addition to their ornamental appeal, Monarda species are highly valued for their essential oil content. Some species are separated into chemical races based on essential oil content.

We have identified natural inhibitors of soil borne pathogens important in commercial floriculture industry. Dried herbage from one or more Monarda species or cultivars, optionally in combination with dried herbage from one or more other plants offers sought-after control effects when properly prepared and applied as an amendment to commercial greenhouse growing media and the herbage does not negatively affect, and may enhance, the activity of biological control organisms added to seed or growing medium. Examples of pathogens or plant diseases that can be reduced, inhibited, prevented or eliminated include Rhizoctonia Damping Off of geranium, poinsettia, and pansy and Thielaviopsis Black Root Rot of pansy. In one embodiment of the subject invention, top dressing with a herbage (fresh or dried foliage) biomulch from two plants that inhibit seed germination and which can eliminate or reduce weed invasion. In a preferred embodiment, the biomulch is obtained from Monarda species of plants.

Monarda species produce high quantities of essential oils. To date, there has been no attempt to utilize herbage (fresh or dried foliage) of Monarda plants which produce high amounts of essential oils as a delivery system for the essential oil. In these preliminary tests, we found a decided difference in components of essential oils between the different Monarda plants. Both the native species and one commercial variety produce carvacrol, thymol, geraniol and cymene. We have found that geraniol, thymol and carvacrol completely inhibit growth of two plant pathogenic fungi, Alternaria and Sclerotinia; and that cymene will reduce the growth of Alternaria. We have also found that the native species produces an additional compound called limonene which we have found to also inhibit the growth of Alternaria, but not as effectively as cymene. The inhibitory activity of geraniol, thymol and carvacrol against the sclerotia of Sclerotinia; this is exciting because sclerotia are among the most resistant structures produced by fungi.

In Monarda, composition of these oils varies among species, race and hybrid/cultivar. Monarda species produce high quantities of essential oils. For example, Monarda punctata plants contain 10,000-30,000 ppm, and M. fistulosa plants have 3,000-31,000 ppm. It has also been shown that essential oil content varies among plant parts. Monarda didyma flowers contain 3,700 ppm, but leaves contain 7,000-13,000 ppm. Shoots of M. didyna contain 1,000-10,000 ppm, and shoots of M. citriodora contain 10,000 ppm. Composition of the oils also varies among plant parts. For example, thymol (62%) and p-cymene (23%) were most abundant, and γ-terpinene was present only in trace amounts in leaves of M. citriodora var. citriodora, but thymol (51%) and γ-terpinene (13%) were the most abundant in flowers. The high content of geraniol and citral makes Monarda a potentially high value crop. In preliminary studies, we have determined that Monarda plants grown in eastern Tennessee contain high concentrations of geraniol and carvacrol; p-cymene is also present in both plants but at lower concentrations. Limonone was present in minor amounts and only in M. Fistulosa. All of these compounds are fungicidal, and all (except carvacrol) have been reported to have herbicidal properties. In preliminary greenhouse studies, we have found that Monarda herbage mixed with growing media significantly delayed seed germination and inhibited seedling growth of both tomato and Vinca. We know that at low concentrations the components of the Monarda herbage are not phytotoxic because a ‘tea’ (1 g herbage steeped in 100 ml water for 3 hours) had no effect when sprayed on tomatoes and a dilution of 1:200 herbage:greenhouse growing medium had no effect on seed germination or seedling growth.

Since weeds are a problem in perennial plant container production, the subject invention, in one embodiment, provides for the use ground herbage of Monarda and/or Chenopodium as a top dressing after the perennial plant is potted in methods for the control of weed growth or germination of weed seeds. Top dressing (preferably of ground herbage at depths of about ¼ inch to about 3 inches, preferably about ½ inch to about 2 inches, or about ¾ inch to about 1½ inches) is one preferred embodiment because 1) it uses less plant material than mixing herbage into the greenhouse potting soil, 2) it concentrates the material at the site of entry for the weed seed, and 3) it increases the distance between the roots of the perennial plant and the biologically active compounds found in the herbage. Geraniol, limonene and p-cymene are insoluble in water so they will not readily wash though the potting system; they should only be released upon partial degradation of the herbage thus effecting a slow release into the greenhouse growing medium (GGM) while maintaining high concentrations near the top of the pot. Through natural breakdown of the herbage, phytochemicals will be slowly released into the growing medium at concentrations below that of phytotoxicity; however, the subject invention also provides for methods of controlling weed growth or the germination of weed seed comprising the amendment of potting soils with ground herbage of Monarda chamaemelum, Matricaria and/or Chenopodium. For example, the subject invention provides for the use of Monarda and/or Chenopodium herbage to control or inhibit growth of weeds common in perennial plant production [e.g., Hairy Bittercress (Cardamine hirsuta), Yellow Wood Sorrel (Oxalis stricta) and Red-Leaf Wood Sorrel (Oxalis rufa)].

We have also found that ground herbage and/or the essential oil components of Monarda didyma are effective against Sclerotinia, one of the most recalcitrant soilborne pathogens. Accordingly the subject invention provides for the addition of Monarda herbage to growing media to deliver these compounds for control of soilborne diseases. Development of a growing medium which controls soilborne diseases in bedding plants and potted flowering crops will be a significant contribution to the industry. This growing medium has the potential to be commercially manufactured and marketed. This could lead to the commercial production of this beautiful fragrant herb for use as a growing media amendment.

Thus, the subject invention provides methods of controlling weeds, plant pests, or plant pathogens comprising the application of a bioactive herbage (plant material) composition to: 1) soil or greenhouse growing media, or nursery growing media as an amendment or 2) as top dressing for potted plants in amounts sufficient to control weeds, plant pests, or plant pathogens. Various embodiments provide for the application of a bioactive herbage composition obtained from: a) Monarda spp.; b) Chamaemelum spp.; c) Matricaria spp.; d) Chenopodium spp; or e) various combinations of a), b), c), and d). In some embodiments, the bioactive herbage composition is, optionally, dried. In other embodiments, epazote is also provided in the composition. Yet other embodiments provide of the subject invention provide for the use of bioactive herbage compositions that comprise additional bioactive herbage (plant material) and wherein said additional bioactive herbage is, optionally, dried. Typically, the additional bioactive herbage has one or more activity selected from the group consisting of: a) allelochemic activity; b) allelopathic activity; c) anti-helminthic activity; d) antibiotic activity; e) anti-bacterial activity; f) anti-microbial activity; g) anti-viral activity; h) anti-ascaricide activity; i) bacteriostatic activity; j) candidicide activity; k) candidistat activity; l) disinfectant activity; m) fungicide activity; n) fungistat activity; o) herbicide activity; p) herbistat activity; q) herbicide-safener activity; r) insecticide-synergist activity; s) phytoalexin activity; t) phytotoxic activity; and u) spice activity. Some embodiments of the invention provide for the use of a bioactive herbage composition that has 1, 2, 3, 4, 5, 6, 7, 8, 9, 10, 11, 12, 13, 14, 15 16, 17, 18, 19, 20, or 21 of said activities.

Also provided by the subject invention are bioactive herbage compositions comprising: a) Monarda spp.; b) Chamaemelum spp.; c) Matricaria spp.; d) Chenopodium spp; or e) various combinations of a), b), c), and d). In some embodiments, the bioactive herbage composition is, optionally, dried. In other embodiments, epazote is also provided in the composition. Yet other embodiments provide of the subject invention provide for the addition of other bioactive herbage (plant material) and wherein said additional bioactive herbage is, optionally, dried. Typically, the additional bioactive herbage has one or more activity selected from the group consisting of: a) allelochemic activity; b) allelopathic activity; c) anti-helminthic activity; d) antibiotic activity; e) anti-bacterial activity; f) anti-microbial activity; g) anti-viral activity; h) anti-ascaricide activity; i) bacteriostatic activity; j) candidicide activity; k) candidistat activity; l) disinfectant activity; m) fungicide activity; n) fungistat activity; o) herbicide activity; p) herbistat activity; q) herbicide-safener activity; r) insecticide-synergist activity; s) phytoalexin activity; t) phytotoxic activity; and u) spice activity. Some embodiments of the invention provide for a bioactive herbage composition that has 1, 2, 3, 4, 5, 6, 7, 8, 9, 10, 11, 12, 13, 14, 15 16, 17, 18, 19, 20, or 21 of the aforementioned activities.

Additional plant materials (bioactive herbage) that are suitable for the formulation of compositions; ground herbage; addition to greenhouse growing media, nursery growing media, or soils as an amendment; top dressing for potted plants; or use in the methods taught in the subject application are as follows (scientific name (Common name): portion of plant suitable for use in the invention):

Plants/Herbage With Allelochemic Activity

Origanum vulgare (Common Turkish Oregano): Plant; Coriandrum sativum (Chinese Parsley: Fruit; Foeniculum vulgare (Fennel): Fruit; Camellia sinensis (Tea): Leaf; Cinnamomum verum (Ceylon Cinnamon): Bark; Daucus carota (Carrot): Root; Lycopersicon esculentum (Tomato): Fruit; Mentha x piperita subsp. nothosubsp. piperita (Peppermint): Leaf; Ribes nigrum (Black Currant): Fruit; Vaccinium corymbosum (Blueberry): Fruit; Artemisia dracunculus (Tarragon): Shoot; Chamaemelum nobile (Garden Camomile): Plant; Humulus lupulus (Hops): Fruit; Laurus nobilis (Bay): Leaf; Myrtus communis (Arrayan (Sp.): Plant; Rosinarinus officinalis (Rosemary): Plant; Ruta graveolens (Rue): Plant; Vaccinium myrtillus (Bilberry): Leaf; Vitis vinifera (European Grape): Fruit; Aloysia citrodora (Lemon Verbena): Plant; Capsicum annuum (Bell Pepper): Fruit;

Plants/Herbage With Allelopathic Activity

Foeniculum vulgare (Fennel): Fruit; Acorus calamus (Calamus): Rhizome; Glechoma hederacea (Alehoof): Plant; Lepechinia calycina (Epling's Lepechinia): Plant; Ocimum basilicum (Basil): Plant; Pycnanthemum tenuifolium (Slenderleaf Mountain Mint): Shoot; Salvia sclarea (Clary Sage): Plant; Satureja douglasii (Douglas' Savory): Plant; Zingiber officinale (Ginger): Rhizome; Capsicum frutescens (Cayenne): Fruit; Coriandrum sativum (Chinese Parsley): Fruit; Elettaria cardamomum (Cardamom): Fruit; Hedeoma drummondii (Drummond's Pennyroyal): Plant; Lavandula latifolia (Aspic): Plant; Lavandula x intermedia (Dutch Lavender): Plant; Levisticum officinale (Lovage): Root; Mentha longifolia (Biblical Mint): Shoot; Myristica fragrans (Mace): Seed; Myrtus communis (Arrayan (Sp.): Plant; Peumus boldus (Boldo): Leaf; Piper nigrum (Black Pepper): Fruit;

Plants/Herbage With Anti-helminthic Activity

Dryopteris filix-mas (Male Fern): Rhizome; Origanum vulgare (Common Turkish Oregano): Plant; Mentha pulegium (European Pennyroyal): Plant; Rosinarinus officinalis (Rosemary): Plant; Salvia officinalis (Sage): Plant; Satureja hortensis (Summer Savory): Plant; Thymus serpyllum (Creeping Thyme): Plant; Thymus vulgaris (Common Thyme): Plant; Caniellia sinensis (Tea): Leaf; Coriandrum sativum (Chinese Parsley): Fruit; Glycyrrhiza glabra (Commom Licorice): Root; Juniperus sabina (Sabine): Plant; Monarda fistulosa (Wild Bergamot): Plant; Myrtus communis (Arrayan (Sp.): Plant; Pycnanthemum virginianum (Virginia Mountain Mint): Shoot; Satureja montana (Savory): Plant; Thymus capitatus (‘Sicilian’ Thyme): Plant; Zea mays (Corn): Silk Stigma Style; Thymus zygis subsp. sylvestris (‘Portuguese’ Thyme): Shoot; Achillea millefolium (Milfoil): Plant; Aloysia citrodora (Lemon Verbena): Plant; Cucumis melo subsp. ssp melo var. cantalupensis (Cantaloupe): Seed; Cucumis sativus (Cucumber): Seed; Cucurbita pepo (Pumpkin): Seed;

Plants/Herbage With Antibiotic Activity

Allium cepa (Onion): Bulb; Tulipa gesneriana (Tulip): Bulb; Allium sativum var. sativum (Garlic): Bulb; Berberis vulgaris (Barberry): Plant; Ginkgo biloba (Ginkgo): Leaf; Glycine max (Soybean): Seed; Helianthus annuus (Girasol): Seed; Inula helenium (Elecampane): Root; Mahonia aquifolium (Blue Barberry): Root; Pteridium aquilinum (Bracken): Plant; Abelmoschus esculentus (Okra): Seed; Acacia catechu (Black Cutch): Plant; Acacia senegal (Gum Arabic): Plant; Actaea pachypoda (American Baneberry): Plant; Actaea rubra (Red Baneberry): Plant; Actaea spicata (European Baneberry): Fruit; Adonis vernalis (Spring Adonis): Plant; Allium ampeloprasum (Elephant Garlic): Plant; Andira inermis (Cabbage Bark): Bark; Anemone pulsatilla (Pasque Flower): Plant; Annona muricata (Soursop): Plant;

Plants/Herbage With Anti-bacterial Activity

Origanum vulgare (Common Turkish Oregano): Plant; Foeniculum vulgare (Fennel): Fruit; Coriandrum sativum (Chinese Parsley): Fruit; Ribes nigrum (Black Currant): Fruit; Camellia sinensis (Tea): Leaf; Glycyrrhiza glabra (Commom Licorice): Root; Rosmarinus officinalis (Rosemary): Plant; Citrus aurantium (Bitter Orange): Plant; Thymus vulgaris (Common Thyme): Plant; Daucus carota (Carrot): Root; Citrus paradisi (Grapefruit): Fruit; Lycopersicon esculentum (Tomato): Fruit; Mentha spicata (Hortela da Folha Miuda): Leaf; Ocimum basilicum (Basil): Plant; Satureja montana (Savory): Plant; Humulus lupulus (Hops): Fruit; Piper nigrum (Black Pepper): Fruit; Matricaria recutita (Annual Camomile): Plant; Zingiber officinale (Ginger): Rhizome; Citrus reticulata (Mandarin): Fruit; Laurus nobilis (Bay): Leaf;

Plants/Herbage With Anti-microbial Activity

Glycine max (Soybean): Seed; Medicago sativa subsp. sativa (Alfalfa): Plant; Phaseolus coccineus (Scarlet Runner Bean): Plant; Psoralea corylifolia (Babchi): Root; Pueraria pseudohirsuta (Chinese Kudzu): Root; Sophora subprostrata (Shan Dou Gen): Root; Trifolium pratense (Cowgrass): Flower; Vigna radiata (Green Gram): Plant; Baptisia tinctoria (Wild Indigo): Leaf; Brassica oleracea var. gemmifera var. gemmtifera (Brussel-Sprout): Shoot; Cajanus cajan (Pigeonpea): Root; Canavalia ensiformis (Jack Bean): Leaf Diffusate; Crotalaria juncea (Sunhemp): Leaf; Cytisus scoparius (Scotch Broom): Flower; Erythrina crista-galli (Cockspur Coral Tree): Bark; Genista tinctoria (Dyer's Broom): Flower; Glycine max (Soybean): Endosperm; Glycyrrhiza glabra (Commom Licorice): Shoot; Laburnum anagyroides (Golden Chain Tree): Leaf; Lupinus albus (White Lupine): Hypocotyl; Medicago sativa subsp. sativa (Alfalfa): Leaf;

Plants/Herbage With Anti-viral Activity

Origanum vulgare (Common Turkish Oregano): Plant; Lycopersicon esculentum (Tomato): Fruit; Thymus vulgaris (Common Thyme): Plant; Camellia sinensis (Tea): Leaf; Rosmarinus officinalis (Rosemary): Plant; Daucus carota (Carrot): Root; Foeniculum vulgare (Fennel): Fruit; Glechoma hederacea (Alehoof): Plant; Glycine max (Soybean): Seed; Matricaria recutita (Annual Camomile): Plant; Ribes nigrum (Black Currant): Fruit; Vitis vinifera (European Grape): Fruit; Citrus sinensis (Orange): Fruit; Citrus paradisi (Grapefruit): Fruit; Coriandrum sativum (Chinese Parsley): Fruit; Allium cepa (Onion): Bulb; Humulus lupulus (Hops): Fruit; Origanuin majorana (Marjoram): Plant; Nicotiana tabacum (Tobacco): Leaf; Prunus cerasus (Sour Cherry): Plant; Thymus serpyllum (Creeping Thyme): Plant;

Plants/Herbage With Ascaricide Activity

Coriandrum sativum (Chinese Parsley): Fruit; Salvia officinalis (Sage): Plant; Thymus vulgaris (Common Thyme): Plant; Origanum vulgare (Common Turkish Oregano): Plant; Acacia farnesiana (Cassie): Flower; Allium cepa (Onion): Bulb; Allium sativuin var. sativum (Garlic): Bulb; Aloysia citrodora (Lemon Verbena): Plant; Althaea officinalis (Marshmallow): Leaf; Anethum graveolens (Dill): Fruit; Arachis hypogaea (Groundnut): Seed; Areca catechu (Betel Nut): Seed; Armoracia rusticana (Horseradish): Root; Artemisia absinthium (Wormwood): Plant; Artemisia dracunculus (Tarragon): Leaf; Artemisia herba-alba (Desert Wormwood): Plant; Artemisia maritima (Sea Wormwood): Plant; Asarum canadense (Wild Ginger): Rhizome; Asimina triloba (Pawpaw): Fruit; Avena sativa (Oats): Seed; Beta vulgaris subsp. subsp. vulgaris (Beet): Leaf;

Plants/Herbage With Bacteriostatic Activity

Achillea millefolium (Milfoil): Leaf; Acorus calamus (Calamus): Rhizome; Aloysia citrodora (Lemon Verbena): Plant; Alpinia galanga (Greater Galangal): Plant; Anethum graveolens (Dill): Fruit; Angelica archangelica (Angelica): Root; Apium graveolens (Celery): Leaf Essential Oil; Aralia cordata (Udo): Root; Artemisia annua (Annual Mugwort (GRIN)): Plant; Artemisia pallens (Davana): Plant; Capsicum annuum (Bell Pepper): Fruit; Capsicum frutescens (Cayenne): Fruit; Carthamus tinctorius (Safflower): Flower; Carum carvi (Caraway): Plant; Cinnamomum aromaticum (Canela de la China (Sp.): Plant; Cinnamomum camphora (Camphor): Leaf; Cinnamomum verum (Ceylon Cinnamon): Bark; Cistus ladaniferus (Ambreine): Leaf; Citrus aurantiifolia (Lime): Fruit; Citrus aurantium (Bitter Orange): Leaf; Citrus limon (Lemon): Leaf Essential Oil;

Plants/Herbage With Bacteristat Activity

Vitis vinifera (European Grape): Fruit; Artemisia dracunculus (Tarragon): Plant; Camellia sinensis (Tea): Leaf; Citrus paradisi (Grapefruit): Fruit; Eupatorium perfoliatum (oneset): Plant; Polygonum hydropiper (Common Smartweed): Plant; Polygonum hydropiperoides (Mild Water Pepper): Plant; Sorbus aucubaria (Rowan Berry): Fruit; Vaccinium myrtillus (Bilberry): Leaf; Acacia catechu (Black Cutch): Plant; Acacia nilotica (Babul): Plant; Aesculus hippocastanum (Horse Chestnut): Bark; Allium cepa (Onion): Bulb; Allium schoenoprasum (Chives): Leaf; Ammi visnaga (Visnaga): Plant; Anethum graveolens (Dill): Plant; Anogeissus latifolia (Gum Ghatti): Plant; Arctostaphylos uva-ursi (Bearberry): Leaf; Arnica montana (Leopard's-Bane): Flower; Berberis vulgaris (Barberry): Plant; Brassica oleracea var. botrytis l. var. botrytis (Cauliflower): Flower;

Plants/Herbage With Candidicide Activity

Glycyrrhiza glabra (Commom Licorice): Root; Mentha spicata (Hortela da Folha Miuda): Leaf; Citrus reticulata (Mandarin): Fruit; Mentha pulegium (European Pennyroyal): Plant; Ribes nigrum (Black Currant): Fruit; Origanum vulgare (Common Turkish Oregano): Plant; Coriandrum sativum (Chinese Parsley): Fruit; Cymbopogon citratus (Lemongrass): Plant; Laurus nobilis (Bay): Leaf; Lavandula latifolia (Aspic): Plant; Lycopersicon esculentum (Tomato): Fruit; Ocimum basilicum (Basil): Plant; Piper nigrum (Black Pepper): Fruit; Thymus vulgaris (Common Thyme): Plant; Capsicum frutescens (Cayenne): Fruit; Cinnamomum verum (Ceylon Cinnamon): Bark; Citrus sinensis (Orange): Fruit; Daucus carota (Carrot): Root; Levisticum officinale (Lovage): Root; Mentha longifolia (Biblical Mint): Shoot; Myristica fragrans (Mace): Seed;

Plants/Herbage With Candidistat Activity

Anethuin graveolens (Dill): Plant; Ocimum basilicum (Basil): Plant; Thymus vulgaris (Common Thyme): Plant; Acorus calamus (Calamus): Rhizome; Aesculus hippocastanum (Horse Chestnut): Bark; Apium graveolens (Celery): Fruit Essential Oil; Artemisia dracunculus (Tarragon): Plant; Capsicum frutescens (Cayenne): Fruit; Carum carvi (Caraway): Fruit; Cinnamomum verum (Ceylon Cinnamon): Bark; Citrus aurantium (Bitter Orange): Plant; Citrus reticulata (Mandarin): Fruit; Citrus sinensis (Orange): Fruit; Coriandrum sativum (Chinese Parsley): Fruit; Cymbopogon martinii (Palmarosa): Plant; Daucus carota (Carrot): Seed; Eucalyptus citriodora (Citron-Scented Gum): Leaf; Fraxinus rhynchophylla (Chinese Ash): Bark; Illicium verum (Chinese Star Anise): Fruit; Laurus nobilis (Bay): Leaf; Lavandula latifolia (Aspic): Plant;

Plants/Herbage With Disinfectant Activity

Aconitum napellus (Aconite): Plant; Adonis vernalis (Spring Adonis): Plant; Aesculus hippocastanum (Horse Chestnut): Bark; Allium cepa (Onion): Bulb; Allium schoenoprasum (Chives): Leaf; Alocasia macrorrhiza (Giant Taro): Plant; Anabasis aphylla (Anabasis): Plant; Ananas comosus (Pineapple): Fruit; Annona muricata (Soursop): Plant; Annona squamosa (Sugar-Apple): Plant; Apium graveolens (Celery): Pt; Arctostaphylos uva-ursi (Bearberry): Leaf; Avena sativa (Oats): Petiole; Berberis vulgaris (Barberry): Plant; Beta vulgaris subsp. subsp. vulgaris (Beet): Root; Brassica oleracea var. botrytis l. var. botrytis (Cauliflower): Flower; Brassica oleracea var. gemmifera var. gemmifera (Brussel-Sprout): Leaf; Brassica oleracea var. capitata l. var. capitata (Cabbage): Leaf; Brassica oleracea var. sabellica l. var. acephala (Curly Kale): Leaf; Brassica oleracea var. gongylodes (Kohlrabi): Stem; Capparis spinosa (Caper): Plant;

Plants/Herbage With Fungicide Activity

Foeniculum vulgare (Fennel): Fruit; Glycyrrhiza glabra (Commom Licorice): Root; Zingiber officinale (Ginger): Rhizome; Daucus carota (Carrot): Root; Coriandrum sativum (Chinese Parsley): Fruit; Glycine max (Soybean): Seed; Ribes nigrum (Black Currant): Fruit; Origanum vulgare (Common Turkish Oregano): Plant; Lycopersicon esculentum (Tomato): Fruit; Piper nigrum (Black Pepper): Fruit; Citrus aurantium (Bitter Orange): Plant; Lavandula latifolia (Aspic): Plant; Myristica fragrans (Mace): Seed; Levisticum officinale (Lovage): Root; Rosmarinus officinalis (Rosemary): Plant; Ocimum gratissimum (Agbo): Plant; Capsicum annuum (Bell Pepper): Fruit; Cinnamomum verum (Ceylon Cinnamon): Bark; Citrus sinensis (Orange): Fruit; Laurus nobilis (Bay): Leaf; Lavandula x intermedia (D)utch Lavender): Plant;

Plants/Herbage With Fungistat Activity

Thymus vulgaris (Common Thyme): Plant; Citrus aurantium (Bitter Orange): Plant; Daucus carota (Carrot): Root; Laurus nobilis (Bay): Leaf; Myristica fragrans (Mace): Seed; Ocimum basilicum (Basil): Plant; Origanum vulgare (Common Turkish Oregano): Plant; Acorus calamus (Calamus): Rhizome; Anethum graveolens (Dill): Plant; Artemisia dracunculus (Tarragon): Plant; Cinnamomum verum (Ceylon Cinnamon): Bark; Coriandrum sativum (Chinese Parsley): Fruit; Foeniculum vulgare (Fennel): Fruit; Glycyrrhiza glabra (Commom Licorice): Shoot; Levisticum officinale (Lovage): Root; Mentha aquatica (Water Mint): Leaf; Mentha x piperita subsp. nothosubsp. piperita. (Peppermint): Leaf; Myrtus communis (Arrayan (Sp.): ): Plant; Nicotiana tabacum (Tobacco): Leaf; Pycnanthemum clinopodioides (Clinopod Mountain Mint): Shoot; Rosmarinus officinalis (Rosemary): Plant;

Plants/Herbage With Herbicide Activity

Artemisia dracunculus (Tarragon): Shoot; Cinnamomum verum (Ceylon Cinnamon): Bark; Coriandrum sativum (Chinese Parsley): Fruit; Foeniculum vulgare (Fennel): Fruit; Lavandula latifolia (Aspic): Plant; Mentha longifolia (Biblical Mint): Shoot; Mentha pulegium (European Pennyroyal): Plant; Ocimum basilicum (Basil): Plant; Piper nigrum (Black Pepper): Fruit; Zingiber officinale (Ginger): Rhizome; Ocimum gratissimum (Agbo): Plant; Origanum vulgare (Common Turkish Oregano): Plant; Aloysia citrodora (Lemon Verbena): Plant; Chamaemelum nobile (Garden Camomile): Plant; Daucus carota (Carrot): Root; Laurus nobilis (Bay): Leaf; Lavandula x inteimedia (Dutch Lavender): Plant; Levisticum officinale (Lovage): Root; Mentha spicata (Hortela da Folha Miuda): Leaf; Myrtus communis (Arrayan (Sp.): Plant; Pycnanthemum tenuifolium (Slenderleaf Mountain Mint): Shoot;

Plants/Herbage With Herbistat Activity

Trifolium pratense (Cowgrass): Plant; Acacia farnesiana (Cassie): Plant; Acacia tortilis (Umbrella Thorn): Leaf; Adonis vernalis (Spring Adonis): Plant; Artemisia absinthium (Wormwood): Plant; Arundo donax (Giant Reed): Plant; Avena sativa (Oats): Leaf; Baptisia tinctoria (Wild Indigo): Leaf; Daucus carota (Carrot): Plant; Eriodictyon californicum (Bear's Weed): Resin, Exudate, Sap; Hordeum vulgare (Barley): Shoot; Inula helenium (Elecampane): Root; Lupinus albus (White Lupine): Stem; Lycopersicon esculentum (Tomato): Fruit; Lycoris radiata (Spider Lily): Bulb; Lycoris squamigera (Magic Lily): Bulb; Medicago sativa subsp. sativa (Alfalfa): Plant; Momordica charantia (Bitter Melon): Fruit; Morus alba (Sang-Pai-Pi): Leaf; Musa x paradisiaca (Banana): Fruit; Narcissus tazetta (Daffodil): Stem;

Plants/Herbage With Herbicide-Safener Activity

Medicago sativa subsp. sativa (Alfalfa): Plant; Trifoliun pratense (Cowgrass): Flower; Vigna radiata (Green Gram): Plant; Astragalus membranaceus (Huang Qi): Root; Baptisia tinctoria (Wild Indigo): Plant; Cimicifuga racemosa (Black Cohosh): Root; Glycyrrhiza glabra (Commom Licorice): Root; Pueraria pseudohirsuta (Chinese Kudzu): Root; Sophora angustifolia (Narrowleaf Sophora): Root; Sophora japonica (Japanese Pagoda Tree): Plant;

Plants/Herbage With Insecticide-Synergist Activity

Sesamum indicum (Ajonjoli (Sp.): Seed; Perilla frutescens (Perilla): Leaf; Anethum graveolens (Dill): Fruit; Apium graveolens (Celery): Plant; Arctium lappa (Burdock): Plant; Carum carvi (Caraway): Fruit; Coriandrum sativum (Chinese Parsley): Fruit; Daucus carota (Carrot): Root; Eleutherococcus senticosus (Ci wu jia (Pinyin):): Root; Foeniculum vulgare (Fennel): Fruit; Levisticum officinale (Lovage): Seed; Myristica fragrans (Mace): Leaf; Oenanthe aquatica (Water Fennel): Fruit; Oenanthe crocata (Water Dropwort): Plant; Oenanthe javanica (Javan Water Dropwort): Fruit; Pastinaca sativa (Parsnip): Root Essential Oil; Petroselinum crispum (Parsley): Leaf; Pimipinella anisum (Anise): Plant; Piper nigrum (Black Pepper): Fruit; Sassafras albidum (Sassafras): Root; Vaccinium corymbosum (Blueberry): Fruit;

Plants/Herbage With Phytoalexin Activity

Daucus carota (Carrot): Root; Brassica oleracea var. capitata l. var. capitata (Cabbage): Leaf; Foeniculum vulgare (Fennel): Fruit; Glycyrrhiza glabra (Commom Licorice): Root; Angelica sinensis (Chinese Angelica): Root; Phaseolus coccineus (Scarlet Runner Bean): Plant; Phaseolus lunatus (Butter Bean): Leaf; Angelica dahurica (Bai Zhi): Root; Apium graveolens (Celery): Plant; Coriandrum sativum (Chinese Parsley): Fruit; Glehnia littoralis (Bei Sha Shen): Rhizome; Glycine max (Soybean): Seed; Ruta graveolens (Rue): Plant; Trifolium pratense (Cowgrass): Plant; Angelica archangelica (Angelica): Plant; Apium graveolens (Celery): Pt; Arachis hypogaea (Groundnut): Sprout Seedling; Baptisia tinctoria (Wild Indigo): Leaf; Capsicum annuum (Bell Pepper): Fruit; Chenopodium album (Lambsquarter): Plant; Daucus carota (Carrot): Shoot;

Plants/Herbage With Phytotoxic Activity

Gentiana acaulis (Stemless Gentian): Root; Gentiana lutea (Gentian): Root; Gentiana scabra (Japanese Gentian): Root; and/or

Plants/Herbage With Spice Activity

Alliaria petiolata (Garlic Mustard): Plant; Allium schoenoprasum (Chives): Plant; Arnoracia rusticana (Horseradish): Root; Brassica juncea (Mustard Greens): Seed; Brassica nigra (Black Mustard): Seed; Brassica oleracea var. botrytis l. var. botrytis (Cauliflower): Leaf; Brassica oleracea var. gemmifera var. gemmifera (Brussel-Sprout): Seed; Brassica oleracea var. capitata l. var. capitata (Cabbage): Leaf.

### EXAMPLES

### Example 1

Antifungal activity of the essential oil components against Rhizoctonia and Pythium will be tested by means previously used to evaluate Alternaria growth. Briefly, a cotton swab saturated with the oil is suspended above a culture of the test pathogen. Fungal dry weight is then determined. Appropriate controls are performed.

### Example 2

Forty four cultivars of M. didyma and five other species will be grown under uniform field conditions in the South Eastern region of the United States (at the University of Tennessee, Knoxville, Tenn.). The study will be a complete randomized block design. Plants will be replicated four times within the research plot. Those species which are perennials will be field planted during the month of September to ensure establishment before the winter season while those which are annuals will be greenhouse produced and field planted in mid April.

Leaves from Monarda citriodora, M. fistulosa and M. didyma will be harvested. Essential oils will be collected either by steam distillation (the most commonly used method), supercritical extraction or by hexane extraction. Extracts will be dried, and qualitative analysis will be performed using GC-MS (UT Chemistry Department). Based on these analyses, quantitative HPLC or GC protocols will be developed, and quantitative/qualitative analyses for several species and cultivars will be performed. HPLC protocols may be somewhat complicated by the similarities between components of the essential oils, and multiple runs may be necessary for complete analysis.

### Example 3

Based on the above results, three cultivars will be selected for future research. We will select one that contains few or no essential oil components and two that produce high quantities of thymol, carvacrol, geraniol or other components that inhibit or reduce Sclerotinia, Rhizoctonia or Pythium growth. Monarda herbage will be collected, dried and ground to pass a 10 mesh screen. In order to determine phytotoxicity, herbage will be added to a commercial greenhouse growing medium in a dilution series. We will plant Begonia, Impatiens and Geranium seed and determine if herbage reduces germination and/or seedling quality. Dilutions which do not have a phytotoxic effect on seedlings will be evaluated for phytotoxicity against Geranium and Poinsettia cuttings and also for antifungal activity. In initial experiments, sclerotia of Sclerotinia will be placed in a fine mesh bag buried in the herbage-potting soil combination and removed at various times. Viability will be determined by growth on selective agar. Dilutions which are fungicidal will be evaluated for control of damping off diseases caused by Pythium and Rhizoctonia.

Plant material. At the end of the season, Monarda plants (various cultivars) were field dried and ground to a fine powder. After grinding this powder was stored in air tight glass jars (one pint Mason) at −20 C. In preliminary tests this powder inhibited tomato and Vinca seed germination and seedling growth at dilutions as low as 1 part herbage to 20 parts commercial greenhouse growing medium. Coarsely ground C. ambrosiodes, is available commercially as epazote and will be purchased from Penzey's Spices (world wide website: penzeys.com: 1-800-741-7787).

Seed Germination tests. Monarda herbage and epazote will be tested for inhibition of Oxalis and pepperweed. Seeds will be tested for germination. Numbers of seed used will be corrected for germination. Seeds will be planted in five dilutions (herbage only, 1:1 herbage:GGM, 1:2 herbage:GGM, 1:10 herbage:GGM, GGM only). Each treatment will be placed into a well of 6-well plastic culturing plates; ten seeds will be planted into each well. Each treatment will be replicated five times, and the experiment will be repeated twice. In addition, one gram herbage will be steeped in 100 ml hot water for 4 h, and the filtrate used to wet filter paper in a standard plastic Petri plate; ten seeds will be placed on the wetted filter paper and incubated at 25° C. until controls germinate. Filter paper will be rewetted with filtrate as needed.

Perennial Plants. Perennial plants will be purchased from commercial growers. The following plants will be used: Hemerocallis sp. (Day Lilly), Scabiosa columbaria ‘Butterfly Blue’, Rudbeckia fulgida var. sullivantii ‘Goldsturm’, Echinacea purpurea ‘Magnus’, and Sedum X, ‘Autumn Joy’. Plants will be potted using standard industry methods. After transplanting is complete, a top dressing (approximately ½ inch) of Monarda herbage and/or epazote will be applied. Each treatment-plant combination will be replicated five times, and the experiment will be repeated once. Plant growth and quality will be monitored biweekly.

Chemical Composition. Essential oils of Monarda and Chenopodium will be extracted by hexane extraction. Dried plant material (0.5 g) will be added to 5 mL hexane and incubated on a shaker for. 18 h. The extract will be analyzed using standard gas-chromatography-mass spectrometry (GC-MS) methods. The GC-MS is the technique of choice for the identification of volatiles in a complex mixture. The GC separates the mixture into individual components, these are presented to the MS for identification. In our laboratories, we have an automated Agilent GC-MS system that is dedicated to essential oil analysis. Monarda powder collected throughout the growing season will be analyzed for herbicidal compounds. Chemical composition of epazote from many manufacturers will be analyzed and compared. Also, batch to batch variation will be monitored.

Use of herbage in a commercial setting. Based on above evaluations of effects on perennial plants, one herbage type will be selected for trials at Mouse Creek Nursery, Riceville, Tenn. Plants will be potted using standard industry methods and Monarda herbage and/or epazote will be added as a top dressing. At least fifteen plants will be treated and compared to fifteen untreated controls. Weed ingress as well as the horticultural parameters outlined above will be monitored.

### Example 4

We have also chosen four popular herbs (Basil, Thyme, Lavender, and Rosemary) as model crops because of their economic significance. In addition, we have chosen soilborne pathogens as models for disease control because the financial and environmental costs for controlling these pathogens are high and control strategies for these pathogens are amenable to soil amendments. Thus, the subject invention provides for methods of controlling damping-off (root rot) pathogens such as Pythium, Fusarium, Sclerotium, and Rhizoctonia in greenhouse herb production comprising the addition of Monarda herbage and/or epazote: 1) to soils, or 2) as a top dressing.

Preliminary Data. A rapid GC/MS evaluation technique developed in our laboratory has been used to analyze the chemical composition of more than 1000 samples; 100 of these have been assayed for biological activity. We have shown that variability exists among Monarda, both between species and within cultivars of the same species, in chemical composition and in concentration of bioactive compounds. Under controlled laboratory and greenhouse conditions, Monarda herbage inhibits the growth of Fusarium and Rhizoctonia, and kills sclerotia of Sclerotinia when added to planting medium. When tomato seeds were planted into a greenhouse growing medium with and without (w/wo) Monarda herbage and w/wo R. solani inoculum, differences between treatment combinations were due to the main effects of either Monarda or R. solani. In Rhizoctonia-infested medium, percent germination and plant height increased with the addition of herbage from two out of three selected Monarda cultivars (P≧0.05); disease decreased significantly with the addition of herbage from one of two cultivars tested (P≧0.05). In similar tests with geranium, seedling height was greater than control with herbage from two of the three cultivars tested (P≧0.05) and disease was reduced by herbage from all three Monarda cultivars. Shelf life testing in laboratory and greenhouse settings has shown that Monarda herbage remains biologically active for at least 12 months.

The subject invention provides for optimized delivery of antifungal activity into commercial growing medium by delivery of essential oil components that can be controlled by regulating particle size. We have also optimized efficacy without compromising plant quality/yield or causing harm to biological control organisms by adjusting ratios of Monarda herbage to greenhouse growing medium and the timing of application of biocontrol organisms to realize disease control benefits without compromising plant quality or impacting biological control organisms.

Herbage can be ground to pass a 1 mm or a 5 mm mesh screen. We have designed as a 3-way factorial with particle size, sample times, and at least five Monarda cultivars. The experiment is arranged in a completely randomized design, with 3 replicates per treatment combination. Samples are collected weekly and analyzed by GC/MS. The study will be repeated. Appropriate statistical analysis will be performed including the Regression Procedure of PC-SAS, the Mixed Procedure of PC-SAS, and an F-protected LSD test at P=0.05.

Oils of Monarda will be collected by supercritical extraction and used to treat inoculum of several commercially-available biocontrol products and Beauveria bassiana 11-98, an isolate with activity against R. solani. Cotton swabs will be saturated with oils and suspended above inoculum for one week; then inoculum will be placed on an appropriate medium and growth determined by organism-specific methods. There will be ten replicate cultures, and the experiment will be repeated twice. Data will be analyzed by Mixed Models with means separation. EC₅₀ values will be calculated. The interaction of biocontrol agents and bioactive herbage will be studied using a 3-way factorial with pathogen (Rhizoctonia or Thielaviopsis), biocontrol agents, and Monarda cultivars. The experiment will be arranged in a completely randomized design, with 3 replicates per treatment combination. The study will be repeated. Separate experiments with vegetative geranium, poinsettia, and pansy will be conducted.

### Example 5

### Utilization of Monarda Plant Material as a Weed Germination Inhibitor in Perennial Production

Twelve cultivars of bee balm (Mondarda didyma) were prepared and evaluated for their ability to prevent the germination of weed seeds in an environment that mimicked a commercial, perennial production operation. Four groups of chamomile were also used in the same manner to determine the pre-emergent qualities (if any) of the essential oils in chamomile.

Materials and Methods

Monarda Preparation

The leaves, stems, and flowers of six cultivars of Mondarda didyina were dried and ground using a mill with a 1 mm sift. These cultivars included ‘Cerise’ (Monarda 10), ‘Puerto Purification’ (Monarda 29), ‘Jacob Cline’ (Monarda 37), ‘Marshall's Delight’ (Monarda 39), ‘Stone's Throw Pink’ (Monarda 42)’ and ‘Rose Scented’ (Monarda 50). This included material that had been harvested throughout the summer of 2001.

The dried, ground plant material was applied to container-grown perennials in an environment similar to that of a commercial perennial production operation. The plants were to a kept in an over-wintering house and moving the plants out into the open in the spring. Two widely available perennials, Phlox paniculata ‘David,’ and Echinacea purpurea ‘Magnus’ were grown in one-gallon nursery pots. Each species was divided into four repetitions of 22 plants each. The Echinacea group also had a modified fifth repetition comprised of 8 plants. Within each repetition were plants that were each treated with different cultivars of Monarda, with some plants receiving only one application of the dried, ground plant material, some two, and some three. These applications were all 100 mL and were made approximately three months apart. The Phlox was treated with Monarda cultivars 10, 29, and 50. The Echinacea was treated with Monarda cultivars 37, 39, and 42. Each repetition also included control plants which received no Monarda applications.

Oberservations were taken periodically to observe the number of weeds that had germinated in each perennial container. The species of weed that appeared in each pot was also noted, as well as any observed animal activity (these specific observations were made in the time before the plants were in a secure over-wintering location).

Chamomile Preparation

Roman chamomile (Chamaenielum nobile) and German chamomile (Matricaria chamomilla) were ground in the same fashion as the Monarda plant material. For each species, plant material from the University of Tennessee Institute of Agriculture (UTIA) Gardens was ground, as well as plant material from commercial sources. The plant material from the garden contained plant parts including flowers, stems, and leaves. The commercial plant material consisted solely of flowers.

Four repetitions of black-eyed Susan, Rudbeckia fulgida ‘Goldsturm’, each containing seventeen plants, were arranged in the same area with the Monarda test groups. The experiment was also to observe weed seed germination in the perennials' containers. These test groups received only one 100 mL application of the chamomile plant material. Observations were made periodically to determine the number of weeds that had germinated.

Results

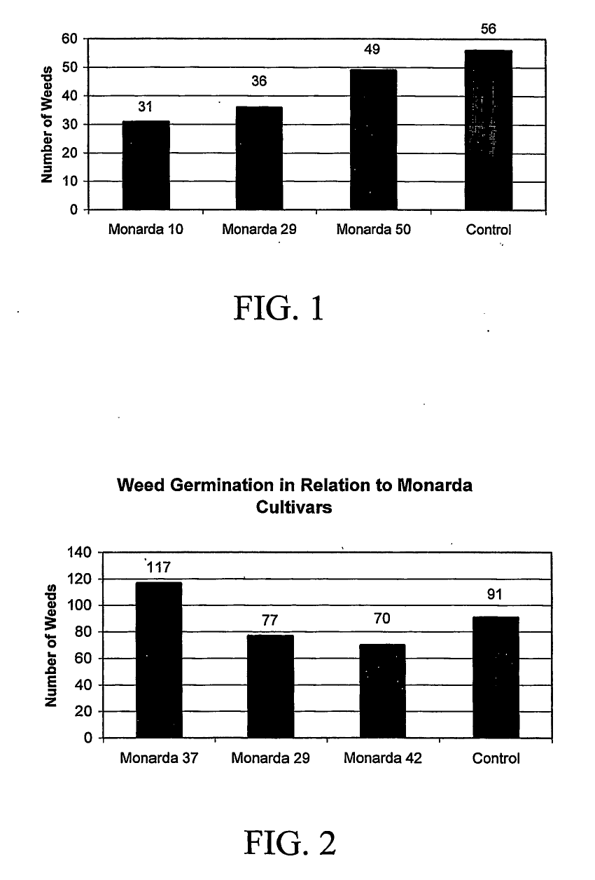

With the exception of Monarda 10, all the containers treated with Monarda plant material experienced lower amounts of weeds. Also present is a dramatic difference in the total of numbers of weeds in the Echinacea and Phlox experiment groups. This is probably attributable to the timing differences between the times the plants were treated with Monarda and the time they were placed in over-wintering houses. The Echinacea containers were allowed to sit outside in the open for approximately two weeks between being in the greenhouse and being put in the over-wintering house. The Phlox on the other hand, were taken directly from the greenhouse to the over-wintering house. The differences in outdoor exposure likely decreased the number of weed seed to which the containers were exposed (see FIGS. 1 and 2).

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

Appendix 1 illustrates the control of damping off of Tomato by M. didyina.

APPENDIX 1
Monarda species and cultivars used:

| | Species | Cultivar | Source |
|---|---|---|---|
| 1. | M | astromontana | Shumway |
| 2. | M. | bradburiana | Native Gardens |
| 3. | M. | clinopodia | Native Gardens |
| 4. | M. | fistula Claire Grace | Mouse Creek |
| 5. | M. | fistulosa | Native Gardens |
| 6. | M. | punctata | Bluebird |
| 7. | M.d. | Adam | Sandy mush |
| 8. | M.d. | Alba | Bluebird |
| 9. | M.d. | Aquarius | Cedar springs |
| 10. | M.d. | Beauty of Cobham | Sunny Border |
| 11. | M.d. | Blaustrumpf | Cedar springs |
| 12. | M.d. | Chilhowee Lake | S. Hamilton |
| 13. | M.d. | Colrain Red | Sunny Border |
| 14. | M.d. | Experimental #8813 | Canadian Research Ctr |
| 15. | M.d. | Goldmelisse | Morning Glory |
| 16. | M.d. | Hamilton's Red | S. Hamilton's Grandfather |
| 17. | M.d. | Kardinal | Sunny Border |
| 18. | M.d. | Native Red | Sandy Mush |
| 19. | M.d. | Stone's Throw Pink | Sunny Border |
| 20. | M.d. | Twins | Sunny Border |
| 21. | M.d. | Cambridge Scarlet | Bluebird |
| 22. | M.d. | Cerise | Cedar Springs |
| 23. | M.d. | Cherokee | Heronswood |
| 24. | M.d. | Croftway Pink | Bluebird |
| 25. | M.d. | Dark Ponticum | Heronswood |
| 26. | M.d. | Elsie's Lavender | Heronswood |
| 27. | M.d. | Fishes | Sandy mush |
| 28. | M.d. | Gardenview Scarlet | Cedar Springs |
| 29. | M.d. | Jacob Cline | Mouse Creek |
| 30. | M.d. | Lavender | Sandy Mush |
| 31. | M.d. | Little Miriam | Sandy Mush |
| 32. | M.d. | Mahogany | Cedar Springs |
| 33. | M.d. | Marshall's Delight | Mouse Creek |
| 34. | M.d. | Mohawk | Heronswood |
| 35. | M.d. | Mrs. Perry | Andre Viette |
| 36. | M.d. | Panorama Mix | Shumway |
| 37. | M.d. | Petite Delight | Niche |
| 38. | M.d. | Pisces | Heronswood |
| 39. | M.d. | Prairie Night | Cedar Springs |
| 40. | M.d. | Purple Crown | Sandy Mush |
| 41. | M.d. | Purple Mildew | Resistant Bluebird |
| 42. | M.d. | Raspberry Wine | Sandy Mush |
| 43. | M.d. | Sagittarius | Heronswood |
| 44. | M.d. | Scorpion | Cedar Springs |
| 45. | M.d. | Sioux | Heronswood |
| 46. | M.d. | Snow White | Cedar Springs |
| 47. | M.d. | Trinity Purple | Sandy Mush |
| 48. | M.d. | Vintage White | Heronswood |
| 49. | M.d. | Violet Queen | Sandy Mush |

M.d. = Monarda didyma

1-21. (canceled)

22. A method of controlling weeds, plant pests, or plant pathogens comprising the application of a bioactive herbage (plant material) composition to: 1) soil, greenhouse growing media, or nursery growing media as an amendment; or 2) as top dressing for potted plants in amounts sufficient to control weeds, plant pests, or plant pathogens, wherein said bioactive herbage is obtained from: a) Monarda spp.; b) Chamaemelum spp.; c) Matricaria spp.; d) Chenopodium spp; or e) various combinations of a), b), c), and d).

23. The method according to claim 22, wherein said bioactive herbage is obtained from Monarda spp.

24. The method according to claim 22, wherein said bioactive herbage is obtained from Chamaemelum spp.

25. The method according to claim 22, wherein said bioactive herbage is obtained from Matricaria spp.

26. The method according to claim 22, wherein said bioactive herbage is obtained from Chenopodium spp.

27. The method according to claim 22, wherein said bioactive herbage composition comprises a mixture of bioactive herbage obtained from: a) Monarda spp.; b) Chamaemelum spp. and/or Matricaria spp.; and, optionally, d) Chenopodium spp. or epazote.

28. The method according to claim 22, wherein said bioactive herbage compositions contains dried bioactive herbage.

29. The method according to claim 22, wherein said bioactive herbage composition comprises additional bioactive herbage (plant material) and wherein said additional bioactive herbage is, optionally, dried.

30. The method according to claim 29, wherein said bioactive herbage composition has one or more activity selected from the group consisting of: a) allelochemic activity; b) allelopathic activity; c) anti-helminthic activity; d) antibiotic activity; e) anti-bacterial activity; f) anti-microbial activity; g) anti-viral activity; h) anti-ascaricide activity; i) bacteriostatic activity; j) candidicide activity; k) candidistat activity; l) disinfectant activity; m) fingicide activity; n) fingistat activity; o) herbicide activity; p) herbistat activity; q) herbicide-safener activity; r) insecticide-synergist activity; s) phytoalexin activity; t) phytotoxic activity; and u) spice activity.

31. A method of controlling weeds, plant pests, or plant pathogens comprising the application of a bioactive herbage (plant material) composition to soil or greenhouse growing media or nursery growing media as an amendment or as a top dressing for potted plants.

32. The method according to claim 31, wherein said bioactive herbage composition comprises dried bioactive herbage.

33. The method according to claim 31, wherein said bioactive herbage composition has one or more activity selected from the group consisting of: a) allelochemic activity; b) allelopathic activity; c) anti-helminthic activity; d) antibiotic activity; e) anti-bacterial activity; f) anti-microbial activity; g) anti-viral activity; h) anti-ascaricide activity; i) bacteriostatic activity; j) candidicide activity; k) candidistat activity; l) disinfectant activity; m) fungicide activity; n) fungistat activity; o) herbicide activity; p) herbistat activity; q) herbicide-safener activity; r) insecticide-synergist activity; s) phytoalexin activity; t) phytotoxic activity; and u) spice activity.

34. The method according to claim 33, wherein said bioactive herbage composition has 1, 2, 3, 4, 5, 6, 7, 8, 9, 10, 11, 12, 13, 14, 15 16, 17, 18, 19, 20, or 21 of said activities.

35. The method according to claim 34, wherein said bioactive herbage composition comprises bioactive plant material or herbage obtained from:
a) one or more plants with allelochemic activity selected from the group consisting of: Origanum vulgare (Common Turkish Oregano): Plant; Coriandrum sativum (Chinese Parsley: Fruit; Foeniculum vulgare (Fennel): Fruit; Camellia sinensis (Tea): Leaf; Cinnamomum verum (Ceylon Cinnamon): Bark; Daucus carota (Carrot): Root; Lycopersicon esculentum (Tomato): Fruit; Mentha x piperita subsp. nothosubsp. piperita (Peppermint): Leaf; Ribes nigrum (Black Currant): Fruit; Vaccinium corymbosum (Blueberry): Fruit; Artemisia dracunculus (Tarragon): Shoot; Chamaemelum nobile (Garden Camomile): Plant; Humulus lupulus (Hops): Fruit; Laurus nobilis (Bay): Leaf; Myrtus communis (Arrayan (Sp.): Plant; Rosmarinus officinalis (Rosemary): Plant; Ruta graveolens (Rue): Plant; Vaccinium myrtillus (Bilberry): Leaf; Vitis vinifera (European Grape): Fruit; Aloysia citrodora (Lemon Verbena): Plant; Capsicum annuum (Bell Pepper): Fruit; and combinations of said one or more plants;
b) one or more plants with allelopathic activity selected from the group consisting of Foeniculum vulgare (Fennel): Fruit; Acorus calamus (Calamus): Rhizome; Glechoma hederacea (Alehoof): Plant; Lepechinia calycina (Epling's Lepechinia): Plant; Ocimum basilicum (Basil): Plant; Pycnanthemum tenuifolium (Slenderleaf Mountain Mint): Shoot; Salvia sclarea (Clary Sage): Plant; Satureja douglasii (Douglas' Savory): Plant; Zingiber officinale (Ginger): Rhizome; Capsicum frutescens (Cayenne): Fruit; Coriandrum sativum (Chinese Parsley): Fruit; Elettaria cardamomum (Cardamom): Fruit; Hedeoma drummondii (Drummond's Pennyroyal): Plant; Lavandula latifolia (Aspic): Plant; Lavandula x intermedia (Dutch Lavender): Plant; Levisticum officinale (Lovage): Root; Mentha longifolia (Biblical Mint): Shoot; Myristica fragrans (Mace): Seed; Myrtus communis (Arrayan (Sp.): Plant; Peumus boldus (Boldo): Leaf; Piper nigrum (Black Pepper): Fruit; and combinations of said one or more plants;
c) one or more plants with anti-helminthic activity selected from the group consisting of Dryopteris filix-mas (Male Fern): Rhizome; Origanum vulgare (Common Turkish Oregano): Plant; Mentha pulegium (European Pennyroyal): Plant; Rosmarinus officinalis (Rosemary): Plant; Salvia officinalis (Sage): Plant; Satureja hortensis (Summer Savory): Plant; Thymus serpyllum (Creeping Thyme): Plant; Thymus vulgaris (Common Thyme): Plant; Camellia sinensis (Tea): Leaf; Coriandrum sativum (Chinese Parsley): Fruit; Glycyrrhiza glabra (Commom Licorice): Root; Juniperus sabina (Sabine): Plant; Monarda fistulosa (Wild Bergamot): Plant; Myrtus communis (Arrayan (Sp.): Plant; Pycnanthemum virginianum (Virginia Mountain Mint): Shoot; Satureja montana (Savory): Plant; Thymus capitatus (‘Sicilian’ Thyme): Plant; Zea mays (Corn): Silk Stigma Style; Thymus zygis subsp. sylvestris (‘Portuguese’ Thyme): Shoot; Achillea millefolium (Milfoil): Plant; Aloysia citrodora (Lemon Verbena): Plant; Cucumis melo subsp. ssp melo var.cantalupensis (Cantaloupe): Seed; Cucumis sativus (Cucumber): Seed; Cucurbita pepo (Pumpkin): Seed; and combinations of said one or more plants;
d) one or more plants with antibiotic activity selected from the group consisting of Allium cepa (Onion): Bulb; Tulipa gesneriana (Tulip): Bulb; Allium sativum var. sativum (Garlic): Bulb; Berberis vulgaris (Barberry): Plant; Ginkgo biloba (Ginkgo): Leaf; Glycine max (Soybean): Seed; Helianthus annuus (Girasol): Seed; Inula helenium (Elecampane): Root; Mahonia aquifolium (Blue Barberry): Root; Pteridium aquilinum (Bracken): Plant; Abelmoschus esculentus (Okra): Seed; Acacia catechu (Black Cutch): Plant; Acacia senegal (Gum Arabic): Plant; Actaea pachypoda (American Baneberry): Plant; Actaea rubra (Red Baneberry): Plant; Actaea spicata (European Baneberry): Fruit; Adonis vernalis (Spring Adonis): Plant; Allium ampeloprasum (Elephant Garlic): Plant; Andira inermis (Cabbage Bark): Bark; Anemone pulsatilla (Pasque Flower): Plant; Annona muricata (Soursop): Plant; and combinations of said one or more plants;
e) one or more plants with anti-bacterial activity selected from the group consisting of Origanum vulgare (Common Turkish Oregano): Plant; Foeniculum vulgare (Fennel): Fruit; Coriandrum sativum (Chinese Parsley): Fruit; Ribes nigrum (Black Currant): Fruit; Camellia sinensis (Tea): Leaf; Glycyrrhiza glabra (Commom Licorice): Root; Rosmarinus officinalis (Rosemary): Plant; Citrus aurantium (Bitter Orange): Plant; Thymus vulgaris (Common Thyme): Plant; Daucus carota (Carrot): Root; Citrus paradisi (Grapefruit): Fruit; Lycopersicon esculentum (Tomato): Fruit; Mentha spicata (Hortela da Folha Miuda): Leaf; Ocimum basilicum (Basil): Plant; Satureja montana (Savory): Plant; Humulus lupulus (Hops): Fruit; Piper nigrum (Black Pepper): Fruit; Matricaria recutita (Annual Camomile): Plant; Zingiber officinale (Ginger): Rhizome; Citrus reticulata (Mandarin): Fruit; Laurus nobilis (Bay): Leaf; and combinations of said one or more plants;
f) one or more plants with anti-microbial activity selected from the group consisting of Glycine max (Soybean): Seed; Medicago sativa subsp. sativa (Alfalfa): Plant; Phaseolus coccineus (Scarlet Runner Bean): Plant; Psoralea corylifolia (Babchi): Root; Pueraria pseudohirsuta (Chinese Kudzu): Root; Sophora subprostrata (Shan Dou Gen): Root; Trifolium pratense (Cowgrass): Flower; Vigna radiata (Green Gram): Plant; Baptisia tinctoria (Wild Indigo): Leaf; Brassica oleracea var. gemmifera var. gemmifera (Brussel-Sprout): Shoot; Cajanus cajan (Pigeonpea): Root; Canavalia ensiformis (Jack Bean): Leaf Diffusate; Crotalaria juncea (Sunhemp): Leaf; Cytisus scoparius (Scotch Broom): Flower; Erythrina crista-galli (Cockspur Coral Tree): Bark; Genista tinctoria (Dyer's Broom): Flower; Glycine max (Soybean): Endosperm; Glycyrrhiza glabra (Commom Licorice): Shoot; Laburnum anagyroides (Golden Chain Tree): Leaf; Lupinus albus (White Lupine): Hypocotyl; Medicago sativa subsp. sativa (Alfalfa): Leaf; and combinations of said one or more plants;
g) one or more plants with anti-viral activity selected from the group consisting of Origanum vulgare (Common Turkish Oregano): Plant; Lycopersicon esculentum (Tomato): Fruit; Thymus vulgaris (Common Thyme): Plant; Camellia sinensis (Tea): Leaf; Rosmarinus officinalis (Rosemary): Plant; Daucus carota (Carrot): Root; Foeniculum vulgare (Fennel): Fruit; Glechoma hederacea (Alehoof): Plant; Glycine max (Soybean): Seed; Matricaria recutita (Annual Camomile): Plant; Ribes nigrum (Black Currant): Fruit; Vitis vinifera (European Grape): Fruit; Citrus sinensis (Orange): Fruit; Citrus paradisi (Grapefruit): Fruit; Coriandrum sativum (Chinese Parsley): Fruit; Allium cepa (Onion): Bulb; Humulus lupulus (Hops): Fruit; Origanum majorana (Marjoram): Plant; Nicotiana tabacum (Tobacco): Leaf; Prunus cerasus (Sour Cherry): Plant; Thymus serpyllum (Creeping Thyme): Plant; and combinations of said one or more plants;
h) one or more plants with ascaricide activity selected from the group consisting of Coriandrum sativum (Chinese Parsley): Fruit; Salvia officinalis (Sage): Plant; Thymus vulgaris (Common Thyme): Plant; Origanum vulgare (Common Turkish Oregano): Plant; Acacia farnesiana (Cassie): Flower; Allium cepa (Onion): Bulb; Allium sativum var. sativum (Garlic): Bulb; Aloysia citrodora (Lemon Verbena): Plant; Althaea officinalis (Marshmallow): Leaf; Anethum graveolens (Dill): Fruit; Arachis hypogaea (Groundnut): Seed; Areca catechu (Betel Nut): Seed; Armoracia rusticana (Horseradish): Root; Artemisia absinthium (Wormwood): Plant; Artemisia dracunculus (Tarragon): Leaf; Artemisia herba-alba (Desert Wormwood): Plant; Artemisia maritima (Sea Wormwood): Plant; Asarum canadense (Wild Ginger): Rhizome; Asimina triloba (Pawpaw): Fruit; Avena sativa (Oats): Seed; Beta vulgaris subsp. subsp. vulgaris (Beet): Leaf; and combinations of said one or more plants;
i) one or more plants with bacteriostatic activity selected from the group consisting of Achillea millefolium (Milfoil): Leaf; Acorus calamus (Calamus): Rhizome; Aloysia citrodora (Lemon Verbena): Plant; Alpinia galanga (Greater Galangal): Plant; Anethum graveolens (Dill): Fruit; Angelica archangelica (Angelica): Root; Apium graveolens (Celery): Leaf Essential Oil; Aralia cordata (Udo): Root; Artemisia annua (Annual Mugwort (GRIN)): Plant; Artemisia pallens (Davana): Plant; Capsicum annuum (Bell Pepper): Fruit; Capsicum frutescens (Cayenne): Fruit; Carthamus tinctorius (Safflower): Flower; Carum carvi (Caraway): Plant; Cinnamomum aromaticum (Canela de la China (Sp.): Plant; Cinnamomum camphora (Camphor): Leaf; Cinnamomum verum (Ceylon Cinnamon): Bark; Cistus ladaniferus (Ambreine): Leaf; Citrus aurantiifolia (Lime): Fruit; Citrus aurantium (Bitter Orange): Leaf; Citrus limon (Lemon): Leaf Essential Oil; and combinations of said one or more platns;
j) one or more plants with bacteristat activity selected from the group consisting of Vitis vinifera (European Grape): Fruit; Artemisia dracunculus (Tarragon): Plant; Camellia sinensis (Tea): Leaf; Citrus paradisi (Grapefruit): Fruit; Eupatorium perfoliatum (Boneset): Plant; Polygonum hydropiper (Common Smartweed): Plant; Polygonum hydropiperoides (Mild Water Pepper): Plant; Sorbus aucubaria (Rowan Berry): Fruit; Vaccinium myrtillus (Bilberry): Leaf; Acacia catechu (Black Cutch): Plant; Acacia nilotica (Babul): Plant; Aesculus hippocastanum (Horse Chestnut): Bark; Allium cepa (Onion): Bulb; Allium schoenoprasum (Chives): Leaf; Ammi visnaga (Visnaga): Plant; Anethum graveolens (Dill): Plant; Anogeissus latifolia (Gum Ghatti): Plant; Arctostaphylos uva-ursi (Bearberry): Leaf; Arnica montana (Leopard's-Bane): Flower; Berberis vulgaris (Barberry): Plant; Brassica oleracea var. botrytis l. var. botrytis (Cauliflower): Flower; and combinations of said plants;
k) one or more plants with candidicide activity selected from the group consisting of Glycyrrhiza glabra (Commom Licorice): Root; Mentha spicata (Hortela da Folha Miuda): Leaf; Citrus reticulata (Mandarin): Fruit; Mentha pulegium (European Pennyroyal): Plant; Ribes nigrum (Black Currant): Fruit; Origanum vulgare (Common Turkish Oregano): Plant; Coriandrum sativum (Chinese Parsley): Fruit; Cymbopogon citratus (Lemongrass): Plant; Laurus nobilis (Bay): Leaf; Lavandula latifolia (Aspic): Plant; Lycopersicon esculentum (Tomato): Fruit; Ocimum basilicum (Basil): Plant; Piper nigrum (Black Pepper): Fruit; Thymus vulgaris (Common Thyme): Plant; Capsicum frutescens (Cayenne): Fruit; Cinnamomum verum (Ceylon Cinnamon): Bark; Citrus sinensis (Orange): Fruit; Daucus carota (Carrot): Root; Levisticum officinale (Lovage): Root; Mentha longifolia (Biblical Mint): Shoot; Myristica fragrans (Mace): Seed; and combinations of said plants;
l) one or more plants with candidistat activity selected from the group consisting of Anethum graveolens (Dill): Plant; Ocimum basilicum (Basil): Plant; Thymus vulgaris (Common Thyme): Plant; Acorus calamus (Calamus): Rhizome; Aesculus hippocastanum (Horse Chestnut): Bark; Apium graveolens (Celery): Fruit Essential Oil; Artemisia dracunculus (Tarragon): Plant; Capsicum frutescens (Cayenne): Fruit; Carum carvi (Caraway): Fruit; Cinnamomum verum (Ceylon Cinnamon): Bark; Citrus aurantium (Bitter Orange): Plant; Citrus reticulata (Mandarin): Fruit; Citrus sinensis (Orange): Fruit; Coriandrum sativum (Chinese Parsley): Fruit; Cymbopogon martinii (Palmarosa): Plant; Daucus carota (Carrot): Seed; Eucalyptus citriodora (Citron-Scented Gum): Leaf; Fraxinus rhynchophylla (Chinese Ash): Bark; Illicium verum (Chinese Star Anise): Fruit; Laurus nobilis (Bay): Leaf; Lavandula latifolia (Aspic): Plant; and combinations of said one or more plants;
m) one or more plants with disinfectant activity selected from the group consisting of Aconitum napellus (Aconite): Plant; Adonis vernalis (Spring Adonis): Plant; Aesculus hippocastanum (Horse Chestnut): Bark; Allium cepa (Onion): Bulb; Allium schoenoprasum (Chives): Leaf; Alocasia macrorrhiza (Giant Taro): Plant; Anabasis aphylla (Anabasis): Plant; Ananas comosus (Pineapple): Fruit; Annona muricata (Soursop): Plant; Annona squamosa (Sugar-Apple): Plant; Apium graveolens (Celery): Pt; Arctostaphylos uva-ursi (Bearberry): Leaf; Avena sativa (Oats): Petiole; Berberis vulgaris (Barberry): Plant; Beta vulgaris subsp. subsp. vulgaris (Beet): Root; Brassica oleracea var. botrytis l. var. botrytis (Cauliflower): Flower; Brassica oleracea var. gemmifera var. gemmifera (Brussel-Sprout): Leaf; Brassica oleracea var. capitata l. var. capitata (Cabbage): Leaf; Brassica oleracea var. sabellica l. var. acephala (Curly Kale): Leaf; Brassica oleracea var. gongylodes (Kohlrabi): Stem; Capparis spinosa (Caper): Plant; and combinations of said one or more plants;
n) one or more plants with fungicide activity selected from the group consisting of Foeniculum vulgare (Fennel): Fruit; Glycyrrhiza glabra (Common Licorice): Root; Zingiber officinale (Ginger): Rhizome; Daucus carota (Carrot): Root; Coriandrum sativum (Chinese Parsley): Fruit; Glycine max (Soybean): Seed; Ribes nigrum (Black Currant): Fruit; Origanum vulgare (Common Turkish Oregano): Plant; Lycopersicon esculentum (Tomato): Fruit; Piper nigrum (Black Pepper): Fruit; Citrus aurantium (Bitter Orange): Plant; Lavandula latifolia (Aspic): Plant; Myristica fragrans (Mace): Seed; Levisticum officinale (Lovage): Root; Rosmarinus officinalis (Rosemary): Plant; Ocimum gratissimum (Agbo): Plant; Capsicum annuum (Bell Pepper): Fruit; Cinnamomum verum (Ceylon Cinnamon): Bark; Citrus sinensis (Orange): Fruit; Laurus nobilis (Bay): Leaf; Lavandula x intermedia (Dutch Lavender): Plant; and combinations of said one or more plants;
o) one or more plants with fungistat activity selected from the group consisting of Thymus vulgaris (Common Thyme): Plant; Citrus aurantium (Bitter Orange): Plant; Daucus carota (Carrot): Root; Laurus nobilis (Bay): Leaf; Myristica fragrans (Mace): Seed; Ocimum basilicum (Basil): Plant; Origanum vulgare (Common Turkish Oregano): Plant; Acorus calamus (Calamus): Rhizome; Anethum graveolens (Dill): Plant; Artemisia dracunculus (Tarragon): Plant; Cinnamomum verum (Ceylon Cinnamon): Bark; Coriandrum sativum (Chinese Parsley): Fruit; Foeniculum vulgare (Fennel): Fruit; Glycyrrhiza glabra (Commom Licorice): Shoot; Levisticum officinale (Lovage): Root; Mentha aquatica (Water Mint): Leaf; Mentha x piperita subsp. nothosubsp. piperita (Peppermint): Leaf; Myrtus communis (Arrayan (Sp.): ): Plant; Nicotiana tabacum (Tobacco): Leaf; Pycnanthemum clinopodioides (Clinopod Mountain Mint): Shoot; Rosmarinus officinalis (Rosemary): Plant; and combinations of said one or more plants;
p) one or more plants with herbicide activity selected from the group consisting of Artemisia dracunculus (Tarragon): Shoot; Cinnamomum verum (Ceylon Cinnamon): Bark; Coriandrum sativum (Chinese Parsley): Fruit; Foeniculum vulgare (Fennel): Fruit; Lavandula latifolia (Aspic): Plant; Mentha longifolia (Biblical Mint): Shoot; Mentha pulegium (European Pennyroyal): Plant; Ocimum basilicum (Basil): Plant; Piper nigrum (Black Pepper): Fruit; Zingiber officinale (Ginger): Rhizome; Ocimum gratissimum (Agbo): Plant; Origanum vulgare (Common Turkish Oregano): Plant; Aloysia citrodora (Lemon Verbena): Plant; Chamaemelum nobile (Garden Camomile): Plant; Daucus carota (Carrot): Root; Laurus nobilis (Bay): Leaf; Lavandula x intermedia (Dutch Lavender): Plant; Levisticum officinale (Lovage): Root; Mentha spicata (Hortela da Folha Miuda): Leaf; Myrtus communis (Arrayan (Sp.): Plant; Pycnanthemum tenuifolium (Slenderleaf Mountain Mint): Shoot; and combinations of said one or more plants;
q) one or more plants with herbistat activity selected from the group consisting of Trifolium pratense (Cowgrass): Plant; Acacia farnesiana (Cassie): Plant; Acacia tortilis (Umbrella Thorn): Leaf; Adonis vernalis (Spring Adonis): Plant; Artemisia absinthium (Wormwood): Plant; Arundo donax (Giant Reed): Plant; Avena sativa (Oats): Leaf; Baptisia tinctoria (Wild Indigo): Leaf; Daucus carota (Carrot): Plant; Eriodictyon californicum (Bear's Weed): Resin, Exudate, Sap; Hordeum vulgare (Barley): Shoot; Inula helenium (Elecampane): Root; Lupinus albus (White Lupine): Stem; Lycopersicon esculentum (Tomato): Fruit; Lycoris radiata (Spider Lily): Bulb; Lycoris squamigera (Magic Lily): Bulb; Medicago sativa subsp. sativa (Alfalfa): Plant; Momordica charantia (Bitter Melon): Fruit; Morus alba (Sang-Pai-Pi): Leaf; Musa x paradisiaca (Banana): Fruit; Narcissus tazetta (Daffodil): Stem; and combinations of said one or more plants;
r) one or more plants with herbicide-safener activity selected from the group consisting of Medicago sativa subsp. sativa (Alfalfa): Plant; Trifolium pratense (Cowgrass): Flower; Vigna radiata (Green Gram): Plant; Astragalus membranaceus (Huang Qi): Root; Baptisia tinctoria (Wild Indigo): Plant; Cimicifuga racemosa (Black Cohosh): Root; Glycyrrhiza glabra (Commom Licorice): Root; Pueraria pseudohirsuta (Chinese Kudzu): Root; Sophora angustifolia (Narrowleaf Sophora): Root; Sophora japonica (Japanese Pagoda Tree): Plant; and combinations of said one or more plants;
s) one or more plants with insecticide-synergist activity selected from the group consisting of Sesamum indicum (Ajonjoli (Sp.): Seed; Perilla frutescens (Perilla): Leaf; Anethum graveolens (Dill): Fruit; Apium graveolens (Celery): Plant; Arctium lappa (Burdock): Plant; Carum carvi (Caraway): Fruit; Coriandrum sativum (Chinese Parsley): Fruit; Daucus carota (Carrot): Root; Eleutherococcus senticosus (Ci wujia (Pinyin):): Root; Foeniculum vulgare (Fennel): Fruit; Levisticum officinale (Lovage): Seed; Myristica fragrans (Mace): Leaf; Oenanthe aquatica (Water Fennel): Fruit; Oenanthe crocata (Water Dropwort): Plant; Oenanthe javanica (Javan Water Dropwort): Fruit; Pastinaca sativa (Parsnip): Root Essential Oil; Petroselinum crispum (Parsley): Leaf; Pimpinella anisum (Anise): Plant; Piper nigrum (Black Pepper): Fruit; Sassafras albidum (Sassafras): Root; Vaccinium corymbosum (Blueberry): Fruit; and combinations of said one or more plants;
t) one or more plants with phytoalexin activity selected from the group consisting of Daucus carota (Carrot): Root; Brassica oleracea var. capitata l. var. capitata (Cabbage): Leaf; Foeniculum vulgare (Fennel): Fruit; Glycyrrhiza glabra (Commom Licorice): Root; Angelica sinensis (Chinese Angelica): Root; Phaseolus coccineus (Scarlet Runner Bean): Plant; Phaseolus lunatus (Butter Bean): Leaf; Angelica dahurica (Bai Zhi): Root; Apium graveolens (Celery): Plant; Coriandrum sativum (Chinese Parsley): Fruit; Glehnia littoralis (Bei Sha Shen): Rhizome; Glycine max (Soybean): Seed; Ruta graveolens (Rue): Plant; Trifolium pratense (Cowgrass): Plant; Angelica archangelica (Angelica): Plant; Apium graveolens (Celery): Pt; Arachis hypogaea (Groundnut): Sprout Seedling; Baptisia tinctoria (Wild Indigo): Leaf; Capsicum annuum (Bell Pepper): Fruit; Chenopodium album (Lambsquarter): Plant; Daucus carota (Carrot): Shoot; and combinations of said plants;
u) one or more plants with phytotoxic activity selected from the group consisting of Gentiana acaulis (Stemless Gentian): Root; Gentiana lutea (Gentian): Root; Gentiana scabra (Japanese Gentian): Root; and combinations of said one or more plants;
v) one or more plants with spice activity selected from the group consisting of Alliaria petiolata (Garlic Mustard): Plant; Allium schoenoprasum (Chives): Plant; Armoracia rusticana (Horseradish): Root; Brassica juncea (Mustard Greens): Seed; Brassica nigra (Black Mustard): Seed; Brassica oleracea var. botrytis l. var. botrytis (Cauliflower): Leaf; Brassica oleracea var. gemmifera var. gemmifera (Brussel-Sprout): Seed; Brassica oleracea var. capitata l. var. capitata (Cabbage): Leaf; or
w) various combinations of said plants of subparagraphs a) through v).

36. A bioactive herbage composition for use as: 1) an amendment to soil, greenhouse growing media, or nursery growing media; or 2) a top dressing for potted plants comprising bioactive herbage obtained from: a) Monarda spp.; b) Chamaemelum spp.; c) Matricaria spp.; d) Chenopodium spp; e) epazote; or various combinations of a), b), c), d) and e) and additional bioactive herbage that has has one or more activity selected from the group consisting of: a) allelochemic activity; b) allelopathic activity; c) anti-helminthic activity; d) antibiotic activity; e) anti-bacterial activity; f) anti-microbial activity; g) anti-viral activity; h) anti-ascaricide activity; i) bacteriostatic activity; j) candidicide activity; k) candidistat activity; 1) disinfectant activity; m) fungicide activity; n) fungistat activity; o) herbicide activity; p) herbistat activity; q) herbicide-safener activity; r) insecticide-synergist activity; s) phytoalexin activity; t) phytotoxic activity; and u) spice activity, wherein said bioactive herbage composition is, optionally, dried.

37. The composition according to claim 36, wherein said additional bioactive herbage composition has 1, 2, 3, 4, 5, 6, 7, 8, 9, 10, 11, 12, 13, 14, 15 16, 17, 18, 19, 20, or 21 of said activities.

38. The composition according to claim 36, wherein said bioactive herbage is obtained from Monarda spp.

39. The composition according to claim 36, wherein said bioactive herbage is obtained from Chamaemelum spp.

40. The composition according to claim 36, wherein said bioactive herbage is obtained from Matricaria spp.

41. The composition according to claim 36, wherein said bioactive herbage is obtained from Chenopodium spp.

42. The composition according to claim 36, wherein said bioactive herbage composition comprises a mixture of bioactive herbage obtained from: a) Monarda spp.; b) Chamaemelum spp. and/or Matricaria spp.; and optionally, c) Chenopodium spp. or d) epazote.
